(19) United States
(12) Patent Application Publication
(10) Pub. No.: US 2017/0233159 A1
(43) Pub. Date: Aug. 17, 2017

(54) EASY-OPEN RECLOSABLE FLOW-WRAP PACKAGE

(71) Applicant: BEMIS COMPANY, INC., Neenah, WI (US)

(72) Inventor: Tara K. Cruz, Appleton, WI (US)

(21) Appl. No.: 15/503,055

(22) PCT Filed: Aug. 13, 2014
(86) PCT No.: PCT/US14/50859

§ 371 Date: Feb. 10, 2017

(51) Int. Cl. B65D 75/58; B32B 7/06; B65D 75/30; B32B 27/08; B65D 65/02; B65D 65/40; B32B 7/12; B32B 27/32

(52) U.S. Cl. CPC B65D 75/5855; B32B 7/12; B32B 7/06; B32B 27/32; B32B 27/08; B65D 65/02; B65D 65/40; B65D 75/30; B65D 75/5805; B32B 2439/70; B32B 2307/514; B32B 2307/31; B32B 2309/105; B65D 2575/586

(57) ABSTRACT

The present invention is directed to a peel-open, reclosable package formed from a single thermoplastic laminate comprising a first film laminated to a second film. The package includes a peelable, resealable heat-seal seam adhering an interior surface of a first sealing section of the interior package surface to an interior surface of a second sealing section of the interior package surface. The package also includes an asymmetric cross-sectional seal interface formed at the peelable, resealable heat-seal seam by disjoining a segment of the first film from the first sealing section prior to heat sealing the first and second sealing sections together.

### BACKGROUND OF THE INVENTION

The present invention relates generally to primary packaging and more particularly, to easy-open flow-wrap packages formed from flexible packaging film which includes a peelable resealable heat-seal seam so that they may more readily be torn open through the seam.

Flow-wrap type packages are often used for shipping and storage of a variety of food products and non-food products. Flow-wrap packages are typically formed from a continuous polymeric film or web to envelop a product during assembly or formation of the package. The continuous film is formed into a tube through a folding box and after the forming of this tube, a set of rotating sealing wheels makes a longitudinal seal called a fin seal by application of sufficient heat and pressure to the film to cause the two bonding surfaces of the film to heat seal or fuse together. Methods and equipment for forming heat seals are well known to those skilled in the art. A fin seal is an “inner-face to inner-face” abutment or seam where a first section of the interior surface of the package is heat sealed to a second section of the interior surface of the package, in opposition to an overlap or lap seal, which is an “inner-face to outer-face” abutment where an interior surface of the package is heat sealed to the exterior surface of the package. Conventional fin seals have a symmetric heat-seal interface where the film structure sealed to one side of the interface is a mirror-image of the film structure sealed to the other side of the interface. A longitudinal fin seal usually extends along a rear face of the package. Once the product is placed into the tube, the cross-seals (or end seals) in the form of a fin seal are formed through the cross-sealing jaws. In most applications, the end fin seal of the package is formed together with the beginning seal of the following package. During the sealing operation, the film is cut to split the adjacent package and the cutting knife is generally built into the sealing jaws. Flow-wrap type packages can be used in vertical form-fill-seal and horizontal form-fill-seal packaging applications.

Conventional flow-wrap packages are opened by tearing an end fin seal or cross-seal. This tearing is generally not guided and does not cross-over the longitudinal fin seal of the package. Consequently, the tearing is stopped by the longitudinal fin seal and further tearing often results in a random breaking of the package.

Peelable resealable polymeric packaging films are well known in the art. These films have been described for example in U.S. Pat. No. 7,422,782 (Haedt et al.), U.S. Pat. No. 7,927,679 (Cruz et al.), U.S. Pat. No. 8,283.010 (Cruz et al.), U.S. Pat. No. 8,283,011 (Cruz et al.), and U.S. Pat. No. 8,329,276 (Cruz), all of which are incorporated herein by reference. They have been constructed with one or more frangible layers which are designed so that they fail within their respective structures when a peeling force is applied. Such failure being by delamination of a multilayer polymeric film or by rupture within the thickness of one or more layers of the polymeric film. However, the use of these peelable, resealable films in flow-wrap packaging applications has been fraught with undesirable consequences. For example, when such film is heat sealed to itself, the seam that is formed includes at least two frangible interfaces because both sections of film on either side of the seal interface are mirror-images of each other. When the seam is pulled apart to open the package, these interfaces exhibit excessive “webbing”, i.e., the creation of thin strings of polymeric fibers stretching between the two sealing surfaces. Excessive webbing is unsightly and may significantly affect the resealability of the package.

Therefore, there is a definite need to provide flow-wrap packages having a peelable resealable heat-seal seam without experiencing the problems discussed above.

### SUMMARY OF THE INVENTION

The present invention is directed to a peel-open, reclosable package formed from a single thermoplastic laminate comprising a first film laminated to a second film. The laminate has a first side, an opposing second side, a top surface and a bottom surface and comprises a first sealing section having an interior surface, and a second sealing section having an interior surface. The package includes a first side edge, an opposing second side edge, a third side edge, and an opposing fourth side edge.

One important aspect of the present invention is that the package include a peelable, resealable heat-seal seam adhering an interior surface of a first sealing section of the package to an interior surface of a second sealing section of the package.

Another important aspect of the present invention is that there is an asymmetric cross-sectional seal interface formed within the peelable, resealable heat-seal seam by disjoining a segment of the first film from the first sealing section prior to heat sealing the first and second sealing sections together.

In one preferred embodiment, the package is formed from two webs of a single thermoplastic laminate and comprises a first fin seal positioned proximal to the first side edge wherein the peelable, resealable heat-seal seam is formed within the first fin seal. The peelable, resealable heat-seal seam includes an asymmetric cross-sectional seal interface. In this embodiment, the package also includes a second fin seal positioned proximal to the opposing second side edge, a third fin seal positioned proximal to the third side edge, and a fourth fin seal positioned proximal to the opposing fourth side edge. It is also contemplated that the peelable, resealable heat-seal seam may not be formed within the first fin seal. In an alternative embodiment, the peelable, resealable heat-seal seam having an asymmetric cross-sectional seal interface is offset from the first fin seal and positioned adjacent to the first fin seal In order to facilitate the opening of this embodiment of the present invention, there may optionally be included either a score line cut into the laminate or a tear strip both of which are positioned between the peelable, resealable heat-seal seam and the first fin seal.

In another preferred embodiment, the package of the present invention may be formed by folding a single thermoplastic laminate upon itself thereby defining a first fold located at the second side edge of the package. The package also includes a first fin seal positioned proximal to the first side edge, a second fin seal positioned proximal to the third side edge and a third fin seal positioned proximal to the opposing fourth side edge. In this embodiment, the peelable, resealable heat-seal seam is formed within the first fin seal and includes an asymmetric cross-sectional seal interface.

In another preferred embodiment, the package of the present invention may be formed by folding a single thermoplastic laminate upon itself thereby defining a first fold located at the first side edge rather than at the second side edge of the package. The package of this embodiment includes a first fin seal positioned proximal the second side edge and opposite to the first fold. This embodiment also includes a second fin seal positioned proximal to the third side edge, and a third fin seal positioned proximal to the opposing fourth side edge. In this embodiment, the peelable, resealable heat-seal seam is not formed within the first fin seal, but is offset from the first fold. The peelable, resealable heat-seal seam includes an asymmetric cross-sectional seal interface. This embodiment may optionally further comprise either a score line cut into the laminate or tear strip each of which is being positioned between the peelable, resealable heat-seal seam and the first fold to facilitate the opening of the package.

In yet another preferred embodiment, the package may be formed by folding a single thermoplastic laminate upon itself thereby defining a first fold located at the first side edge and a second fold located at the second side edge. The package of this embodiment includes a first fin seal positioned between the first and second folds, and a peelable, resealable heat-seal seam formed within the first fin seal. The package also includes a second fin seal positioned proximal to the third side edge, and a third fin seal positioned proximal to the opposing fourth side edge. The peelable, resealable heat-seal seam includes an asymmetric cross-sectional seal interface.

In still yet another preferred embodiment, the package may be formed by folding a single thermoplastic laminate upon itself thereby defining a first fold located at the first side edge and a second fold located at the second side edge. The package of this embodiment includes a first fin seal positioned between the first and second folds, a second fin seal positioned proximal to the third side edge, and a third fin seal positioned proximal to the opposing fourth side edge. This embodiment includes a peelable, resealable heat-seal seam which is not formed with a fin seal, but is offset from the first fold. The peelable, resealable heat-seal seam includes an asymmetric cross-sectional seal interface. This embodiment may optionally further comprise a score line cut into the laminate or tear strip both of which being positioned between the peelable, resealable heat-seal seam and the first fold to facilitate the opening of the package.

In accordance with an important aspect of the present invention, the packages are both peelable and reclosable. In one embodiment, the first film comprises an interior frangible layer comprising a pressure sensitive adhesive resin.

### BRIEF DESCRIPTION OF THE DRAWINGS

Further features and advantages of the present invention will become apparent from the following detailed description, taken in combination with the appended drawings, in which:

FIG. 1 illustrates a schematic view of one embodiment of a laminate used to form the packages according to the present invention.

FIG. 2A illustrates a schematic view of one embodiment of a package according to the present invention.

FIG. 2B illustrates a schematic view of another embodiment of a package according to the present invention.

FIG. 2C illustrates a schematic view of another embodiment of a package according to the present invention.

FIG. 2D illustrates a schematic view of another embodiment of a package according to the present invention.

FIG. 2E illustrates a schematic view of another embodiment of a package according to the present invention.

FIG. 3A illustrates a cross-sectional view of one embodiment of a peelable, resealable heat-seal seam prior to formation of an asymmetric cross-sectional seal interface of the present invention.

FIG. 3B illustrates a cross-sectional view of one embodiment of a peelable, resealable heat-seal seam during the formation of an asymmetric cross-sectional seal interface of the present invention.

FIG. 3C illustrates a cross-sectional view of one embodiment of a peelable, resealable heat-seal seam having an asymmetric cross-sectional seal interface of the present invention.

FIG. 4A illustrates a cross-sectional view of a preferred embodiment of a laminate of the present invention.

FIG. 4B illustrates a cross-sectional view of a preferred embodiment of a peelable, resealable heat-seal seam having an asymmetric cross-sectional seal interface formed from a preferred embodiment of the laminate described in FIG. 4A.

### DETAILED DESCRIPTION OF THE INVENTION

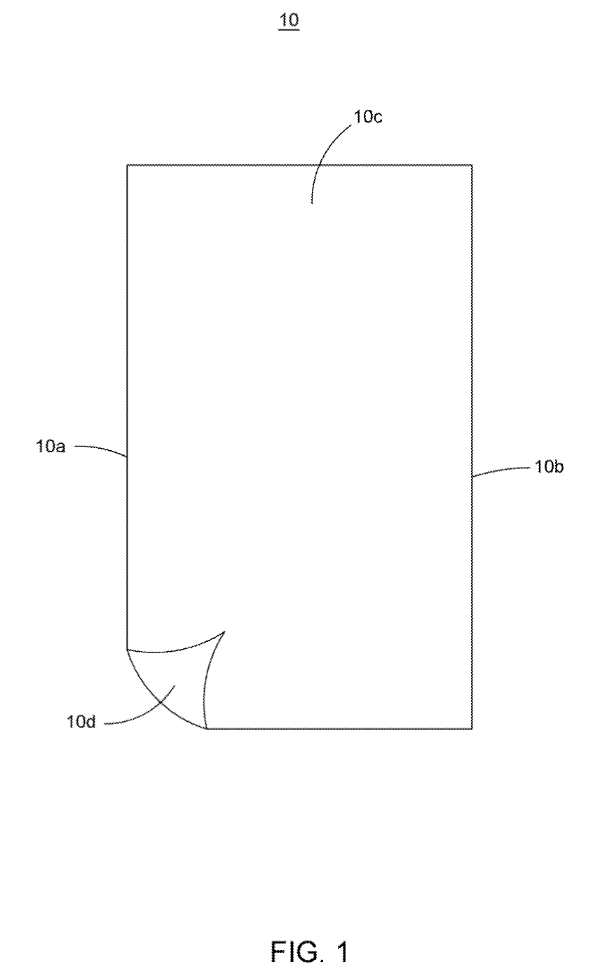

A preferred embodiment of the peel-open, reclosable package of the present invention is made from a single thermoplastic laminate 10 which includes a first laminate side 10a, an opposing second laminate side 10b, a top surface 10c and a bottom surface 10d as depicted in FIG. 1. First laminate side 10a and second laminate side 10b are preferably parallel to each other when laminate 10 is in a flat planar state. As depicted, a corner of laminate 10 is turned upward to reveal bottom surface 10d. In one preferred embodiment, laminate 10 comprises a first film 1100 and a second film 1200 wherein both films are the same. In another preferred embodiment, laminate 10 comprises a first film 1100 and a second film 1200 wherein the first film is different than the second film. In another preferred embodiment, laminate 10 comprises a coextruded multilayer non-oriented first film 1100 and a second film 1200 having at least one oriented layer or layer of paper. In yet another preferred embodiment, laminate 10 comprises a lamination layer 1300 adhering a first film 1100 to a second film 1200.

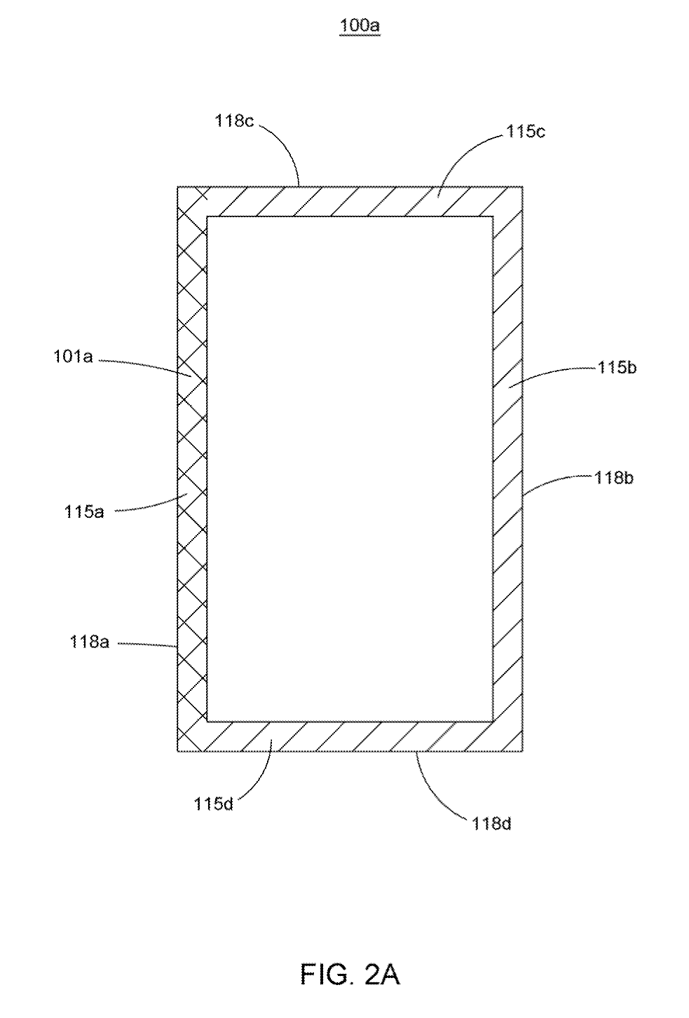

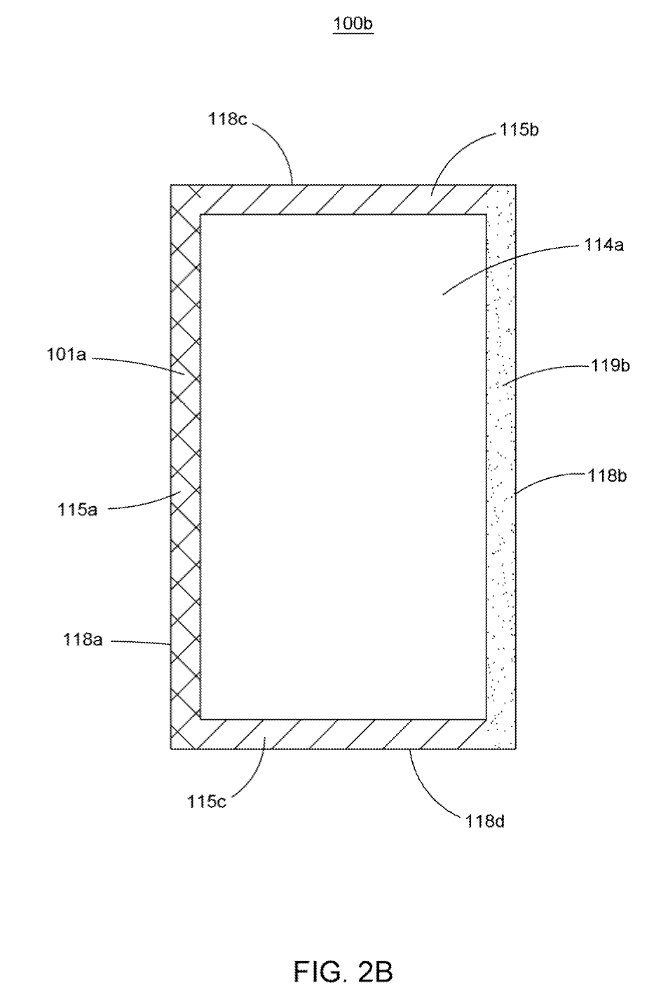

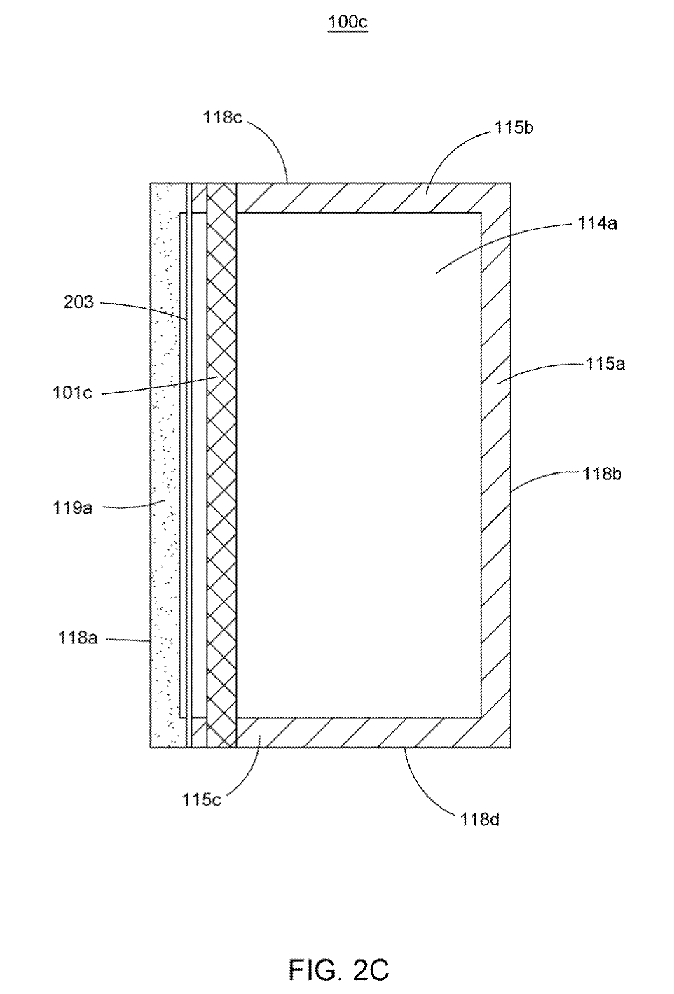

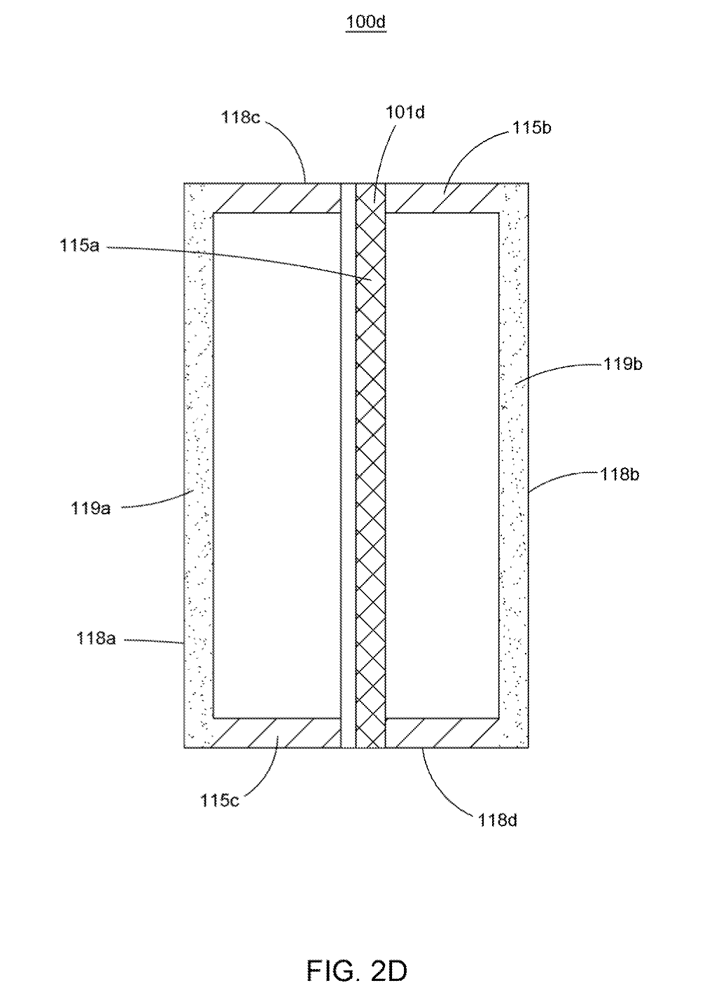

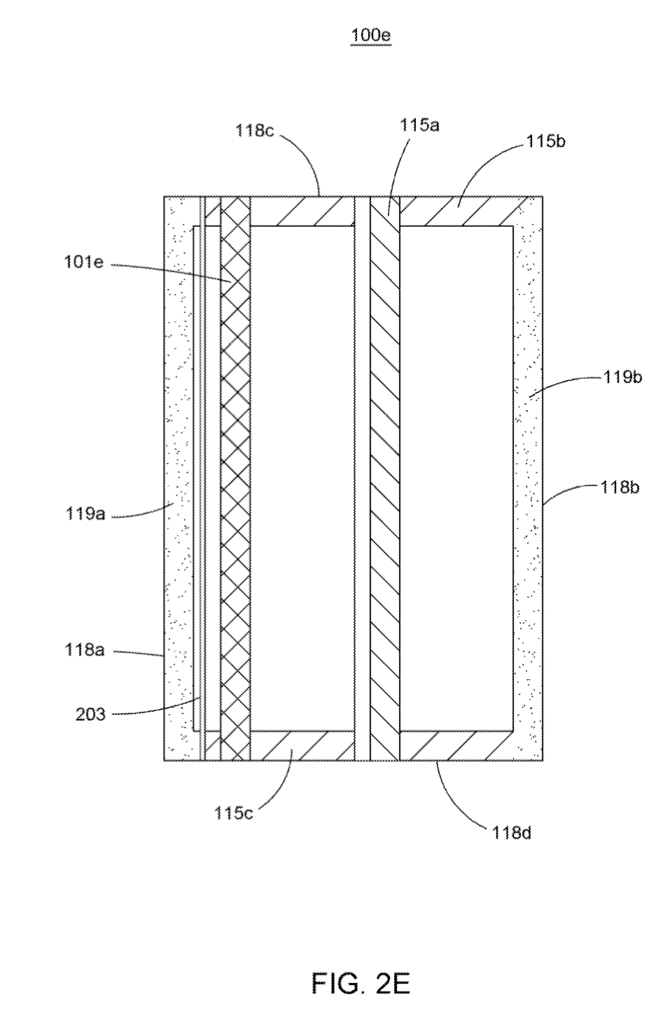

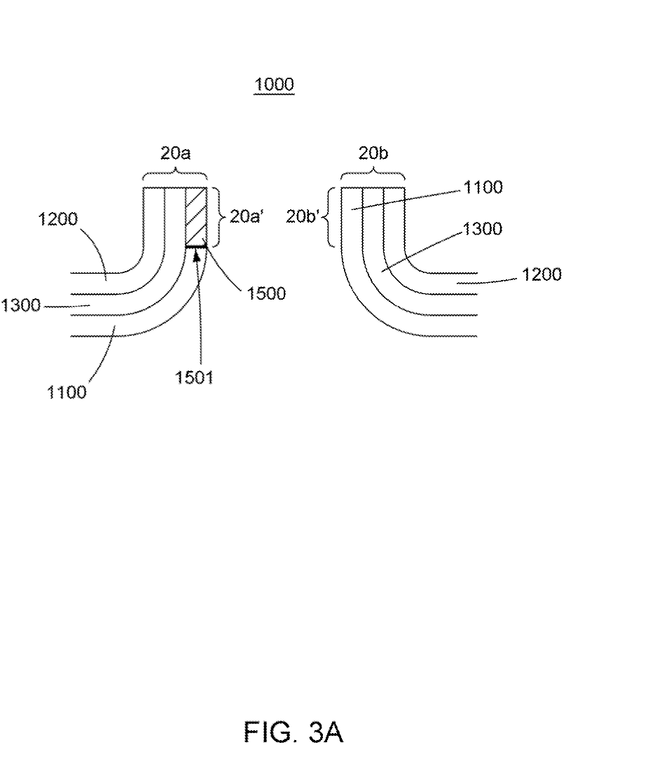

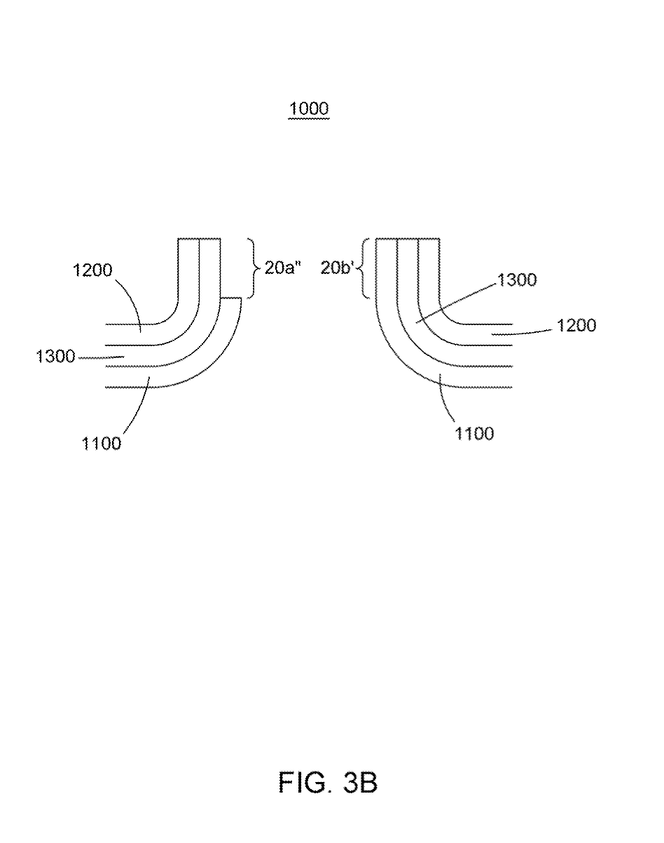

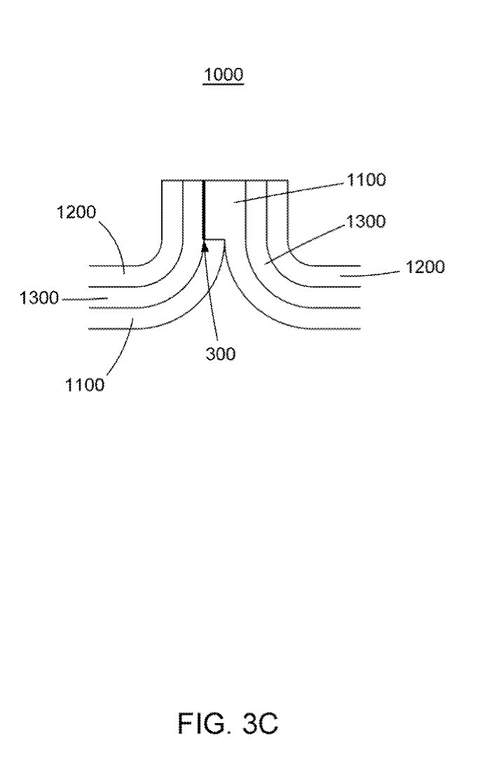

Referring now to FIG. 2A, a preferred embodiment of the present invention is depicted generally as package 100a made from laminate 10 of FIG. 1. Package 100a is formed by heat sealing two webs of laminate 10 together thereby defining package edges as follows: a first side edge 118a, an opposing second side edge 118b, a third side edge 118c, and an opposing fourth side edge 118d. In this embodiment, package 100a includes a first fin seal 115a positioned proximal to the first side edge 118a, a second fin seal positioned proximal to the second side edge 118b, a third fin seal 115c positioned proximal to the third side edge 118c, and a fourth fin seal 115d positioned proximal to the fourth side edge 118d. In this embodiment, a peelable, resealable heat-seal seam 101a having an asymmetric cross-sectional seal interface 500 (illustrated in FIG. 3C below) is present within the first fin seal 115a. Resealable heat-seal seam 101a may extend the entire length of the package or less than the entire length of the package.

FIG. 2B illustrates another preferred embodiment of the present invention.

Package 100b is formed by folding laminate 10 upon itself connecting first laminate side 10a to second laminate side 10b by heat sealing sides 10a and 10b together to produce a first package wall 114a, an opposite second package wall 114b (not shown), a first fin seal 115a positioned proximal to a first side edge 118a, and a first folded edge 119a located at a second side edge 118b. In this preferred embodiment, package 100b also includes a second fin seal 115b positioned proximal to a third side edge 118c, and a third fin seal 115c positioned proximal to a fourth side edge 118d. As can be seen, first fin seal 115a is perpendicular to both second fin seal 115b and third fin seal 115c. In this embodiment, package 100a includes a peelable, resealable heat-seal seam 101b configured within first fin seal 11Sa of the package. As depicted, peelable, resealable heat-seal seam 101a extends substantially from the first package end 118a to the opposing second package end 118b and includes an asymmetric cross-sectional seal interface 500 illustrated in FIG. 3C below.

Alternatively, the present invention can be illustrated in FIG. 2C made from laminate 10 of FIG. 1. As depicted, package 100c is shown in a laid flat condition and includes a first folded edge 119a located at a first side edge 118a, a first package wall 114a, an opposite second package wall 114b (not shown), a first fin seal 115a positioned proximal to a second side edge 118b, a second fin seal 115b seal positioned proximal to a third side edge 118c and a third fin seal 115c positioned proximal to a fourth side edge 118d. As can be seen, first fin seal 115a is configured perpendicular to both second fin seal 115b and third fin seal 115c. In this preferred embodiment, package 100c also includes a peelable, resealable heat-seal seam 101c having an asymmetric cross-sectional seal interface 500. As depicted, peelable, resealable seam 101c is not formed within a fin seal, but is disposed adjacent to the first fold 119a and may extend substantially from the third side end 118c to the opposing fourth package end 118d. Package 100c may optionally include a means to separate folded edge 119a. A means to separate a folded edge may comprise a score line 203 cut into laminate 10 or tear strip (not shown) extending substantially from the third side end 118c to opposing fourth side end 118d, and positioned between peelable, resealable heat-seal seam 101c and first folded edge 119a. The score line or tear strip may be used to aid in accessing peelable, resealable heat-seal seam 101c by separating the first package wall 114a from the second package wall 114b at first folded edge 119a. It should be apparent to those skilled in the art that once package walls 114a and 114b are separated, the consumer may then grasp each wall and manually pull apart peelable, resealable heat-seal seam 101c and thus open the package.

Referring now to FIG. 2D, a preferred embodiment of the present invention is depicted generally as package 100d made from laminate 10 of FIG. 1. Package 100d includes a first fold edge 119a and a second fold edge 119b each located at first side edge 118a and opposing second side edge 118b, respectively. Positioned between first and second side edges 118a and 118b is a first fin seal 115a which extends substantially from third side edge 118c to fourth side edge 118d. Package 100d also includes a second fin seal 115b positioned proximal to third side edge 118c and a third fin seal 116c positioned proximal to fourth side edge 118d. As can be seen, first fin seal 116a is configured perpendicular to both second fin seal 116b and third fin seal 115c. Also included in package 100d is a peelable, resealable heat-seal seam 101d having an asymmetric cross-sectional seal interface 500 (illustrated in FIG. 3C below) formed within first fin seal 115a.

Alternatively, the present invention can be illustrated in FIG. 2E made from laminate 10 of FIG. 1. As depicted, package 100e is shown in a laid flat condition with a peelable, resealable heat-seal seam 101e having an asymmetric cross-sectional seal interface 500 (shown below) which is not formed within a fin seal, but is disposed adjacent to first folded edge 119a and extends substantially from the third side end 118c to the opposing fourth side end 118d. As can be seen, package 100e includes a second folded edge 119b positioned opposite first folded edge 119a such that first fin seal 115a is positioned between first folded edge 119a and second folded edge 119b extending substantially from the first package end 118a to the opposing second package end 118b. Package 100e may optionally include a means to separate folded edge 119a. A means to separate a folded edge may comprise a score line 203 cut into laminate 10 or tear strip (not shown) extending substantially from the third side end 118c to opposing fourth side end 118d, and positioned between peelable, resealable heat-seal seam 101e and first folded edge 119a.

FIGS. 3A, 3B and 3C illustrate the formation of one preferred embodiment of a peelable, resealable seam 1000 for use in with the present invention. Conventional fin seals will be constructed from two identical face-to-face sealing sections having identical film structures or laminate structures as shown in FIG. 3A. Conventional fin seals have a symmetrical cross-sectional sealing interface. In order to achieve an asymmetric cross-sectional sealing interface 300 of the present invention as shown in FIG. 3C, a single thermoplastic laminate 10 is divided into a first sealing section 20a having an interior surface 20a∝ and a second interior sealing film section 20b having an interior surface 20b′. A segment or strip of the first film 1500 is removed from first sealing section 20a before heat sealing it to the second sealing section 20b as depicted in FIG. 3B. When segment 1500 is removed, a new interior surface 20a″ of sealing section 20a is created. There are at least two preferred methods of removing segment 1500 from sealing section 20a. The first preferred method may be used to create a peelable, resealable heat-seal seam within a fin seal such as those shown in FIGS. 2A, 2B and 2D. This first method includes forming a single score line or cut 1501 through the entire thickness of first film 1100 followed by extracting segment 1500 by vacuum immediately prior to laminating first film 1100 to second film 1200 directly or vis--vis lamination layer 1300. The second method may be used to create a peelable, resealable heat-seal seam outside a fin seal such as those illustrated in FIGS. 2C and 2E. This second method includes forming at least two parallel score lines or cuts through the entire thickness of first film 1100 which are spaced apart from each other by a distance of between 0.125 in and 2.0 in (0.32 cm and 5.1 cm) followed by extracting segment 1500 by vacuum immediately prior to laminating first film 1100 to second film 1200. Those skilled in the art will recognize that forming score lines or cuts in thermoplastic materials is well known and may include either a mechanical technique such as a cutting roller or by optical methods using a laser ablation. Once segment 1500 has been removed from first sealing section 20a, the section will have a structure different than the second sealing section 20b. These sections are then heat sealed together to form an asymmetric cross-sectional sealing interface 300 as illustrated in FIG. 3C.

### EXAMPLES

As used herein, the term “frangible layer” refers to one layer or more layers which exhibit adhesive failure, i.e., separation or delamination at an interface from an adjoining layer by application of a pulling or peeling force, or cohesive failure, i.e., separation within the frangible layer by application of a pulling or peeling force. “Peelable seal” and like terminology are used herein to refer to a seal, and especially heat seals, which are engineered to be readily peelable without uncontrolled or random tearing or rupturing the packaging materials which may result in premature destruction of the package and/or inadvertent contamination or spillage of the contents of the package. A peelable seam is one that can be manually peeled apart to open the package at the seal without resort to a knife or other implement to tear or rupture the package. The force required to affect adhesive or cohesive failure of a frangible layer may be measured by its “peel strength” in accordance with ASTM F-904 test methods. A frangible layer is adapted to remain secure and unbroken during package fabrication, distribution and storage, and yet may be relatively easily ruptured. Accordingly, the peel strength of a frangible layer is between 500 gram-force/inch (87.6 Newton/meter) and 5000 gram-force/inch (875.5 Newton/meter) as measured in accordance with ASTM F-904 test method. As used herein, the term “resealable” refers to a film interface formed by adhesive failure between the frangible layer and an adjacent layer and/or cohesive failure within the frangible layer which is adapted to re-adhere to itself after separation. The force required to “reseal” these interfaces is proportional to the manual pressure exerted on the film. Consequently, a peelable and resealable interface will exhibit a first interfacial peel strength and a second interfacial (or re-tack) peel strength. The peelable, resealable fin seals of the present invention will have a first peel strength of between 500 gram-force/inch (87.6 Newton/meter) and 5000 gram-force/inch (875.5 Newton/meter) and a second peel strength of between 350 gram-force/inch (61.3 Newton/meter) and 1000 gram-force/inch (175.1 Newton/meter) as measured in accordance with ASTM F-904 test method.

As used herein, the phrase “asymmetric cross-sectional sealing interface” refers to an “inside-inside” fusion bond or heat seal formed from a single multilayer laminate where there are two “different” structural film sections on either side of the bond interface. As used herein, the term “different” refers to a first structural film section which is not a mirror-image of a second structural film section bonded together at the sealing interface. For example, an asymmetric cross-sectional sealing interface may be represented by the following: A/B/C//B/C/A where “//” is the bond interface, A/B/C is a first structural film section having layer compositions A, B and C; and B/C/A is a second structural film section having the same layer compositions A, B and C as the first section, but are arranged in a different layer sequence. An asymmetric cross-sectional sealing interface may also be represented by the following: A/B/C/D//D/C where is the bond interface, A/B/C/D is a first structural film section having layer compositions A, B, C and D; D/C is a second structural film section having an identical layer compositions C and D as the first section but omits layers A and B. An asymmetric cross-sectional sealing interface may still further be represented by the following: A/B/C/D//D/C/E where “//” is the bond interface, A/B/C/D is a first structural film section having layer compositions A, B, C and D; D/C/E is a second structural film section having an identical layer compositions C and D, but omits layer A and B, and includes layer E which is not present in the first section.

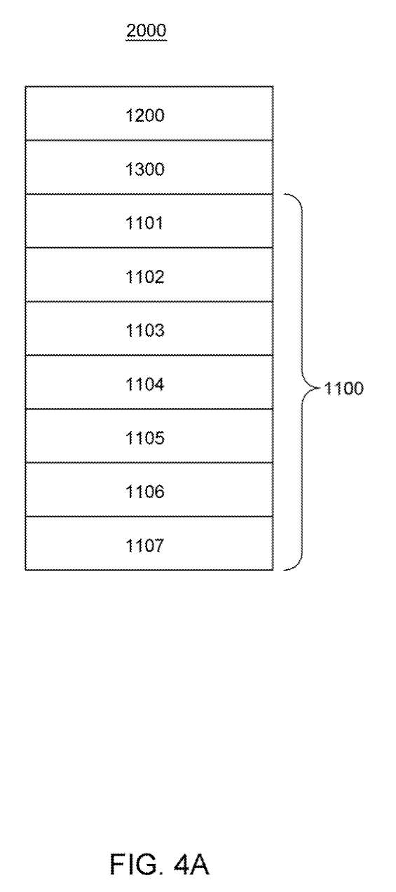

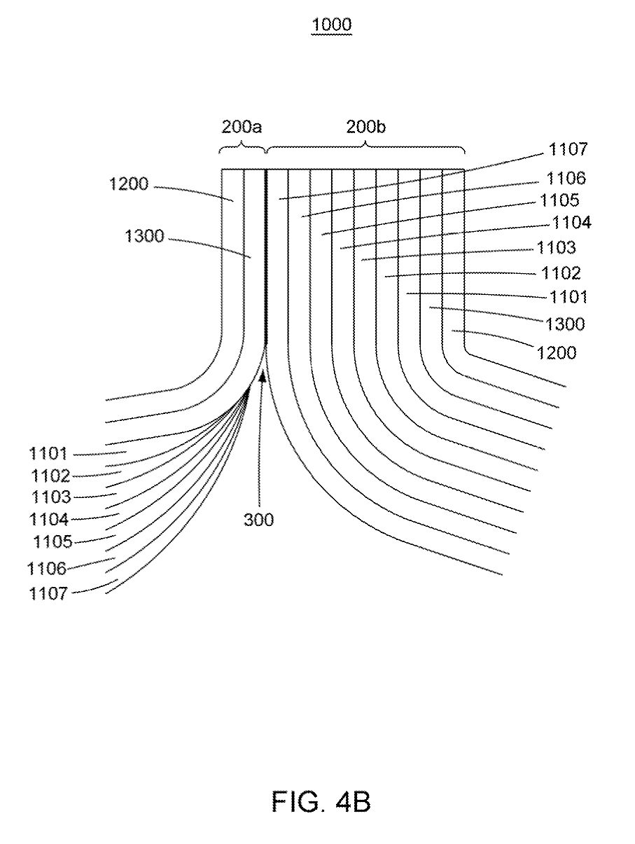

Referring now to FIG. 4A, there is illustrated one preferred embodiment of laminate 2000 comprising a first film 1100, a second film 1200 and a lamination layer 1300. In this example, first film 1100 includes an exterior first layer 1101, an interior second layer 1102 positioned adjacent to the exterior sealant layer 1101, an interior third layer 1103 positioned adjacent to second layer 1102, an interior fourth layer 1104 positioned adjacent to the third layer 1103, an interior fifth layer 1105 positioned adjacent to the fourth layer 1104, an interior sixth layer 1106 positioned adjacent to the fifth layer 1105, and an exterior seventh layer 1107 positioned adjacent to the sixth layer 1106. While this example of first film 1100 is depicted as having seven layers, it should be understood that first film 1100 may be formed with less than seven or more than seven layers. In one preferred embodiment, the exterior first and seventh layers 1101 and 1107 may each comprise a heat sealable material. Heat sealable materials may include but are not limited to polyethylenes such as low density polyethylenes, very low density polyethylenes, ultra-low density polyethylenes, linear low density polyethylenes, ethylene α-olefin copolymers; ethylene vinyl acetate copolymers; ethylene methacrylate copolymers, ethylene acrylic acid copolymers, ionomers and blends thereof. The exterior first and seventh layers 1101 and 1107 may each comprise a blend of anhydride modified polyethylene and un-modified polyethylene. In one preferred embodiment, exterior layer 1107 has a thickness of between 0.1 mil and 1.0 mil (2.54 μm and 25.4 μm). In this embodiment, the interior sixth layer 1106 is a frangible layer comprising a pressure sensitive adhesive. Interior sixth layer 1106 may include a blend of a pressure sensitive adhesive and other materials such as for example, but not limited to low density polyethylene.

The total thickness of first film 1100 of the present invention is generally from about 12.7 μm (0.5 mil) to about 254 μm (10 mil), most typically from about 25.4 μm (1 mil) to about 127 μm (5 mil).

In this particular example, second film 1200 includes a mono-layer structure comprising an oriented material or paper. Oriented materials may include, but are not limited to oriented polyethylene terephthalates, oriented polypropylenes and oriented polyamides. In another embodiment, second film 1200 may include additional layers as desired. In a preferred embodiment, layer 1200 is an oriented polyethylene terephthalate film having a total thickness of between 48 gauge and 142 gauge (12.2 μm and 36.1 μm).

This example also includes a lamination layer 1300. In one embodiment, lamination layer 1300 includes a material which adheres first film 1100 and second film 1200 together. In one preferred embodiment, lamination layer 1300 is heat sealable to both first film 1100 and second film 1200. Materials suitable for use in heat sealing first film 1100 and second film 1200 together may include but are not limited to low density polyethylenes, very low density polyethylenes, ultra-low density polyethylenes, linear low density polyethylenes, ethylene α-olefin copolymers; ethylene vinyl acetate copolymers; ethylene methacrylate copolymers, and blends thereof. Lamination layer 1300 may also include blends of anhydride modified polyethylenes and un-modified polyethylenes. The total thickness of lamination 1300 is generally from between about 0.1 mil and 1.0 mil (2.54 μm and 25.4 μm) and typically from between 0.3 mil and 0.75 mil (7.62 μm and 19.1 μm).

### Working Example

In the following example, the film structure for first film 1100 was produced using a blown film co-extrusion apparatuses, and methods which are well known to those skilled in the art. The blown film co-extrusion film apparatus includes a multi-manifold flat die head for film through which the film composition is forced and formed into a flat sheet. The sheet is immediately quenched e.g., via cooled water bath, solid surface and/or air, and then formed into a film.

In the production of Example 1 as illustrated in FIG. 4A, laminate 2000 may be produced by fabricating first film 1100 using blown film co-extrusion methods. Prior to lamination first film 1100 to second film 1200, a segment of first film 1100 can be removed by scoring into film 1100 and extracting the segment 1500 by vacuum. Then, second film 1200 can be laminated to the exterior layer 1101 of first film 1100 by lamination layer 1300 using extrusion lamination equipment and methods well known to those skilled in the art.

### Example 1

Example 1 is one embodiment of laminate 2000 of the present invention having a structure and layer compositions as described below and as illustrated in FIG. 4A. Reported below is the layer composition relative to the total weight of the layer.
Layer 1200. 100 wt.-% of a 142 gauge biaxially oriented polyethylene terephthalate film (OPET)-Jindal J-201 OPET (Jindal Poly Films Ltd., New Delhi, INDIA).
Layer 1300: 100 wt.-% of a low density polyethylene (LDPE)-Dow™ LDPE 5004I ((Dow Chemical Corporation, Midland, Mich., USA).
Layer 1101: 64.1 wt.-% of a ultra-low density polyethylene (ULDPE)-ATTANE® 4701G (Dow Chemical Corporation, Midland, Mich., USA), 34.8 wt.-% of a linear low density polyethylene (LLDPE)-ExxonMobil™ LLDPE LL 1001.32 (Exxon Mobil Corporation, Houston, Tex., USA) and 1.1 wt.-%o of processing additives.
Layer 1102: 64.1 wt.-% of a ultra-low density polyethylene (ULDPE)-ATTANE® 4701G (Dow Chemical Corporation, Midland, Mich., USA), 34.8 wt.-% of a linear low density polyethylene (LLDPE)-ExxonMobil™ LLDPE LL 1001.32 (Exxon Mobil Corporation, Houston, Tex., USA) and 1.1 wt.-% of processing additives.
Layer 1103: 100 wt.-% of an anhydride modified polyethylene-DuPont™ Bynel® 41E710 (E. I. du Pont de Nemours and Company, Wilmington, Del., USA).
Layer 1104: 100 wt.-% of an ethylene vinyl alcohol copolymer (EVOH)-SOARNOL® ET 3803 (Soarus L.L.C., Arlington Heights, Ill., USA).
Layer 1105: 100 wt.-% of an anhydride modified po ethylene-DuPont™ Bynel® 41E710 (E. I. du Pont de Nemours and Company, Wilmington, Del., USA).
Layer 1106: 100 wt.-% of a pressure sensitive adhesive (PSA)-Bostik MX615 (Bostik, Inc., Wauwatosa, Wis., USA).

Layer 1107: 85 wt.-% of a linear low density polyethylene (LLDPE)-Sclair® FP619-A (Nova Chemicals Corporation, Calgary, Alberta, Canada), 9 wt.-% of an anhydride modified polyethylene-Tymax® GT4300 (Westlake Chemical, Houston, Tex., USA) and 6 wt.-% of a polyethylene masterbatch containing processing additives.

Turning now to FIG. 4B, there is illustrated a cross-sectional view of a preferred embodiment of a peelable, resealable heat-seal seam 1000 having an asymmetric cross-sectional seal interface 300 formed from a preferred embodiment of laminate 2000 as described above in FIG. 4A. In this embodiment, a segment of first film 1200 (layers 1101 to 1107) has been removed from the laminate 2000 to create a first sealing section 200a composed of only lamination layer 1300 and second film 1200 on one side of interface 300. As depicted, first sealing section 200a has been heat sealed to a second sealing section 200b corresponding to an unaltered portion of laminate 2000 composed of first film 1100, lamination layer 1300 and second film 1200 on the opposite side of interface 300. Since a segment of first film has been removed leaving only one frangible layer 1106 present within the peelable, resealable heat-seal seam 1000, when the asymmetric interface 300 is pulled apart to open the package, webbing is greatly reduced or eliminated.

The above description and examples illustrate certain embodiments of the present invention and are not to be interpreted as limiting. Selection of particular embodiments, combinations thereof, modifications, and adaptations of the various embodiments, conditions and parameters normally encountered in the art will be apparent to those skilled in the art and are deemed to be within the spirit and scope of the present invention.

What is claimed:

1. A peel-open, reclosable package formed from a single thermoplastic laminate comprising a first film and a second film, wherein the laminate comprises a first sealing section having an interior surface, and a second sealing section having an interior surface; the package comprising:
a first side edge;
an opposing second side edge;
a third side edge;
an opposing fourth side edge:
a peelable, resealable heat-seal seam adhering the interior surface of the first sealing section to the interior surface of the second sealing section; and
an asymmetric cross-sectional seal interface within the peelable, resealable heat-seal seam formed by disjoining a segment of the first film from the first sealing section prior to heat sealing the first and second sealing sections together.

2. A package according to claim 1, wherein the laminate comprises a lamination layer adhering the first film to the second film.

3. A package according to claim 1, wherein the first film is a coextruded multilayered non-oriented film.

4. A package according to claim 1, wherein the second film is an oriented film.

5. A package according to claim 1, wherein the package comprises a first fin seal positioned proximal to the first side edge and the peelable, resealable heat-seal seam is formed within the first fin seal.

6. A package according to claim 5, wherein the package comprises a second fin seal positioned proximal to the second side edge, a third fin seal positioned proximal to the third side edge and a fourth fin seal positioned proximal to the fourth side edge.

7. A package according to claim 5, wherein the package comprises a first fold located at the second side edge.

8. A package according to claim 7, wherein the package comprises a second fin seal positioned at the third side edge and a third fin seal positioned proximal to the opposing fourth side edge.

9. A package according to claim 1, wherein the package comprises a first fold located at the first side edge, a first fin seal positioned proximal to the second side edge, a second fin seal positioned proximal to the third side edge and a third fin seal positioned proximal to the fourth side edge; wherein the peelable, resealable heat-seal seam is disposed adjacent to the first fold.

10. A package according to claim 9, wherein the package comprises a score line in the laminate or tear strip each positioned between the first fold and the peelable, resealable heat-seal seam.

11. A package according to claim 1, wherein the package comprises first fold located at the first side edge, a second fold located at the second side edge, a first fin seal positioned between the first side edge and the second side edge, a second fin seal positioned proximal the third side edge, a third fin seal positioned proximal to the fourth side edge, wherein the peelable, resealable heat-seal seam is formed within the first fin seal.

12. A package according to claim 1, wherein the package comprises first fold located at the first side edge, a second fold located at the second side edge, a first fin seal positioned between the first side edge and the second side edge, a second fin seal positioned proximal the third side edge, a third fin seal positioned proximal to the fourth side edge, wherein the peelable, resealable heat-seal seam is disposed adjacent to the first fold.

13. A package according to claim 12, wherein the package comprises a score line in the laminate or tear strip each positioned between the first fold and the peelable, resealable heat-seal seam.

14. A package according to claim 1, wherein the first film comprises an interior frangible layer comprising a pressure sensitive adhesive resin.

15. A packaging according to claim 2, wherein the interior surface of the first sealing section is the lamination layer.

16. A package according to claim 1, wherein the interior surface of the second sealing section is an exterior layer of the first film.

17. A package according to claim 16, wherein the exterior layer is positioned adjacent to an interior frangible layer.

18. A package according to claim 17, wherein the exterior layer is a blend of an anhydride modified linear low density polyethylene resin and an un-modified linear low density polyethylene resin.

19. A package according to claim 17, wherein the exterior layer has a thickness of between 0.1 mil and 1.0 mil (2.54μ and 25.4μ).

20. A package according to claim 1, wherein the second film comprises an exterior layer of a material selected from the group consisting of oriented polyethylene terephthalate, oriented polypropylene, oriented polyimide and paper.

21. A package according to claim 20, where the exterior layer of the second film is the exterior package surface.

22. A package according to claim 2, wherein the lamination layer comprises polyethylene.

23. A package according to claim 23, wherein the lamination layer comprises a blend of an ultra-low density polyethylene resin and a linear low density polyethylene resin.

24. A package according to claim 24, wherein the lamination layer has a thickness of between 0.3 mil and 1.0 mil (7.62μ and 25.4μ).

25. A package according to claim 1, where the package is either a vertical flow-wrap package or a horizontal flow-wrap package.
